(19) United States
(12) Patent Application Publication
(10) Pub. No.: US 2015/0184613 A1
(43) Pub. Date: Jul. 2, 2015

(54) PISTON FOR AN INTERNAL COMBUSTION ENGINE

(71) Applicant: MAHLE International GmbH, Stuttgart (DE)

(72) Inventor: Timo Linke, Stuttgart (DE)

(73) Assignee: MAHLE INTERNATIONAL GMBH, Stuttgart (DE)

(21) Appl. No.: 14/415,243

(22) PCT Filed: Jul. 18, 2013
(86) PCT No.: PCT/DE2013/000405

§ 371 Date: Jan. 16, 2015

(30) Foreign Application Priority Data
Jul. 18, 2012 (DE) 10 2012 014 193.9

(51) Int. Cl. F02F 3/22; F02F 3/00

(52) U.S. Cl. CPC F02F 3/22; F02F 3/0015

(57) ABSTRACT

A piston for an internal combustion engine has a piston head and a piston skirt. The piston includes a piston base and a piston ring element and the piston head has a combustion recess. The piston ring element has a portion of a piston crown, a circumferential fire land and a circumferential ring section with ring grooves, in that the piston base and the piston ring element form a circumferential cooling channel that extends between an inner lateral surface in the region of the combustion recess and an outer lateral surface in the region of the ring section, in that in the cooling channel on the outer lateral surface at least one flow guide element and/or on the inner lateral surface at least one heat conducting element is provided; and in that the piston base and the piston ring element have a circumferential seam in the region of the piston crown, via which they are non-detachably connected to one another.

The present invention relates to a piston for an internal combustion engine, having a piston head and a piston skirt, wherein the piston has a piston base body and a piston ring element, and wherein the piston head has a combustion bowl.

German patent application DE 10 2011 111 319.7 discloses a piston having a reduced construction height, which piston is composed of a piston base body and a piston ring element and has a combustion bowl, wherein the piston base body and the piston ring element have a circumferential joining seam in the region of the combustion bowl, by way of which seam they are non-releasably connected with one another.

It is problematic, in this connection, that it is very difficult to impossible to introduce further structures for improving the cooling effect into the cooling channel.

The task of the present invention consists in further developing a piston of the stated type in such a manner that a piston with an improved cooling effect in the region of the piston head can be produced using the simplest possible means.

The solution consists in that the piston ring element has a portion of a piston crown, a circumferential top land, and a circumferential ring belt provided with ring grooves, that the piston base body and the piston ring element form a circumferential cooling channel that is formed between an inner mantle surface in the region of the combustion bowl and an outer mantle surface in the region of the ring belt, that in the cooling channel, at least one flow guide element is provided on the outer mantle surface and/or at least one heat conducting element is provided on the inner mantle surface, and that the piston base body and the piston ring element have a circumferential joining seam in the region of the piston crown, by way of which seam they are non-releasably connected with one another.

The idea according to the invention consists in providing a piston with a piston ring element configured as a separate component, wherein the circumferential cooling channel is formed in part by the piston base body and in part by the piston ring element, and wherein the joining seam is disposed in the region of the piston crown. This structure makes it possible to separately work on the piston base body and the piston ring element in the region of the subsequent cooling channel in such a manner that the inner structure of the cooling channel and thereby its cooling effect can be adapted to the most various requirements of modern internal combustion engines.

According to the invention, at least one flow guide element is provided, which forms a constriction that brings about turbulence in the cooling oil and/or acceleration of the cooling oil flow, so that the cooling effect of the cooling channel is further increased.

Instead or additionally, at least one heat conducting element is provided according to the invention, which element gives off a particularly great heat output to the cooling oil in the cooling channel, at the combustion bowl or at the piston crown, in targeted manner. In this way, the regions of the piston according to the invention that are under particularly great stress are preferentially cooled.

Advantageous further developments are evident from the dependent claims.

Preferably, in order to simplify the production process, the joining seam disposed in the region of the piston crown runs parallel to the center axis of the piston.

The cooling channel can be configured as a closed cooling channel, so that the piston base body and the piston ring element are non-releasably connected with one another in the region of a pin boss connection, by way of a second circumferential joining seam. In order to simplify the production process, this second joining seam can also run parallel to the center axis of the piston.

However, the cooling channel can also be configured to be open in the direction of the piston skirt and closed off with a separate closure element. The closure element is preferably held on the piston ring element in the region of the ring belt, where it can be attached in particularly simple manner.

A preferred further development provides that a circumferential recess is formed between the piston head and the piston skirt. Such a piston, having a thermally uncoupled skirt, is characterized by a great ability to withstand stress. In the case of this piston type, in particular, the cooling channel can be configured to be open in the direction of the piston skirt, in known manner, and be closed off with a separate closure element. Positioning of the joining seam in the region of the piston crown furthermore has the advantage, in the case of a piston having a thermally uncoupled skirt and a cooling channel configured to be open in the direction of the piston crown, that when the piston base body and the piston ring element are joined, welding residues that might occur (for example globules of weld material during the course of a laser welding process) do not remain adhering to the subsequent cooling channel, nor can they exit from the opening of the cooling channel, which has not been closed yet.

The configuration of the piston according to the invention furthermore makes it possible, without problems, to produce a piston having a combustion bowl that is radially offset and/or tilted relative to the center axis of the piston, because the combustion bowl completely formed by the piston base body. It is therefore possible to connect a piston base body having such an asymmetrical configuration with a piston ring element having rotation symmetry.

According to the invention, it is possible to dispose the combustion bowl offset relative to the center axis of the piston by up to 3 mm, something that is not possible in the case of conventional pistons.

If the combustion bowl is disposed to be tilted relative to the center axis of the piston, the center axis of the combustion bowl can enclose an acute angle a of up to 10° with the center axis of the piston.

An inner wall of the cooling channel can run parallel to the center axis of the piston. If the combustion bowl is disposed tilted relative to the center axis of the piston, the inner wall of the cooling channel can also run parallel to the center axis of the combustion bowl. In this way, the cooling effect of the cooling channel is optimized.

Exemplary embodiments of the present invention will be explained in greater detail below, using the attached drawings. These show, in a schematic representation, not true to scale:

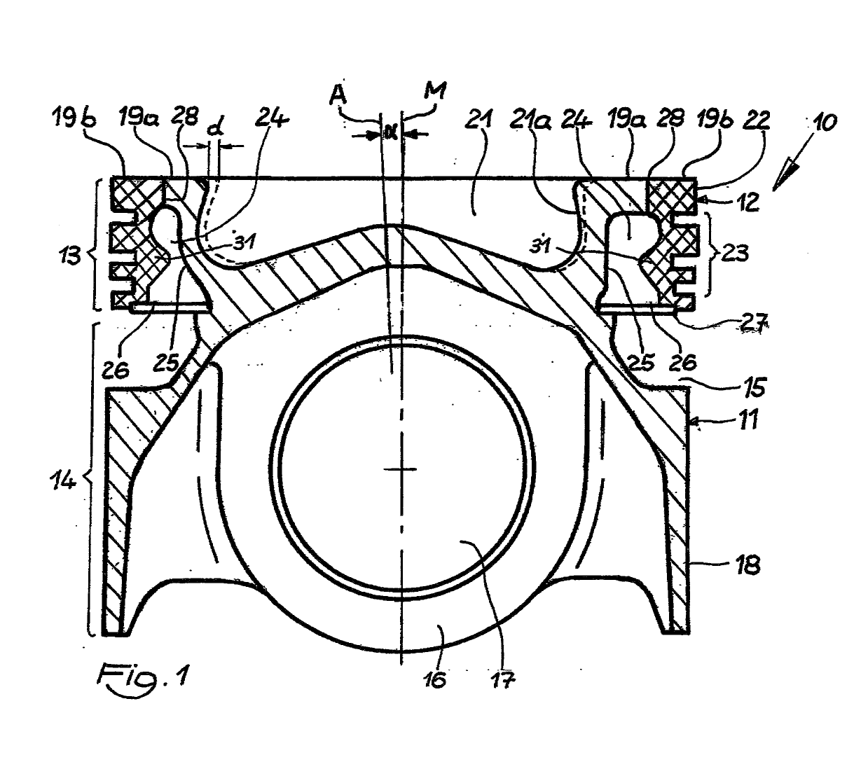

FIG. 1 a first exemplary embodiment of a piston according to the invention in section;

FIG. 2 an enlarged partial representation of a further exemplary embodiment of a piston according to the invention in section;

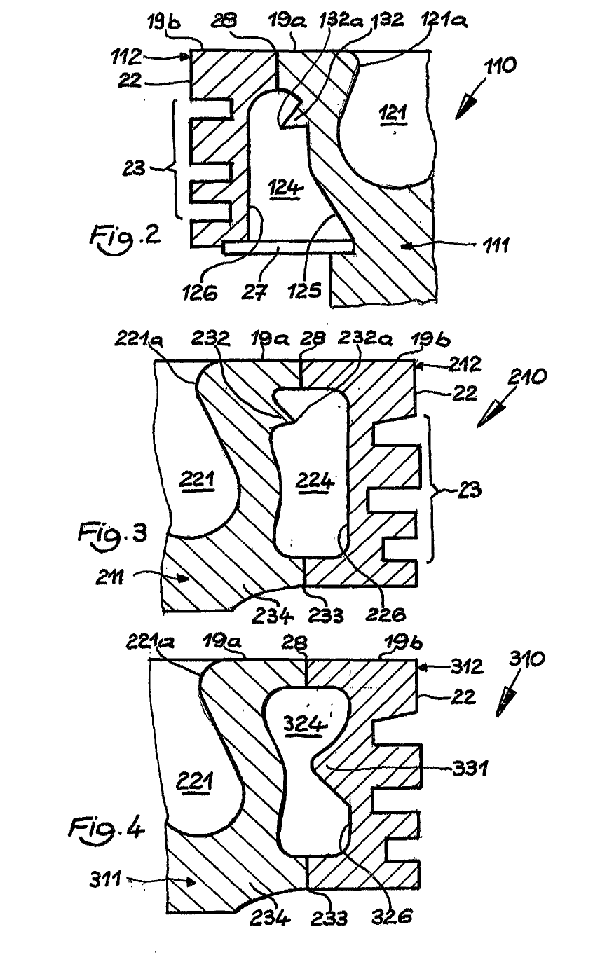

FIG. 3 an enlarged partial representation of a further exemplary embodiment of a piston according to the invention in section;

FIG. 4 an enlarged partial representation of a further exemplary embodiment of a piston according to the invention in section.

FIG. 1 shows a particularly preferred exemplary embodiment of a piston 10 according to the invention. The piston 10 has a piston base body 11 and a piston ring element 12. Both components can consist of any desired metallic material that is suitable for joining of the components. The piston base body 11 and the piston ring element 12 together form the piston head 13 and the piston skirt 14 of the piston 10. In the exemplary embodiment, the piston 10 is a piston having what is called a thermally uncoupled piston skirt, i.e. a circumferential recess 15 is provided between the piston head 13 and the piston skirt 14. However, the present invention can also be used for piston without a thermally uncoupled piston skirt (cf. FIGS. 3 and 4).

The piston skirt 14, in known manner, has pin bosses 16 having pin bores 17 for accommodating a piston pin (not shown), as well as working surfaces 18 that connect the pin bosses 16.

The piston base body 11 furthermore forms an inner portion 19a of a piston crown as well as a combustion bowl 21 in the region of the piston head 13. In the exemplary embodiment, the combustion bowl 21 is radially offset relative to the center axis M of the piston 10. To make this clear, the placement of a combustion bowl that is not offset in the piston head 13 is indicated with a dot-dash line. The radial offset d can amount to as much as 3 mm. In addition, the combustion bowl 21 is tilted relative to the center axis M of the piston 10. This has the result that the center axis M of the piston 10 and the center axis A of the combustion bowl 21 enclose an acute angle of preferably up to 10°. The radial offset d furthermore brings about the result that the inner portion 19a of the piston crown varies in its radial width in the circumferential direction. Furthermore, the radial thickness of the vertical wall 21a of the combustion bowl 21 can vary in the circumferential direction. Of course, the piston can also have a combustion bowl that is merely offset relative to the center axis M of the piston or merely tilted about the center axis M of the piston.

The piston ring element 12 forms an outer portion 19b of the piston crown in the region of the piston head 13 and furthermore has a circumferential top land 22 and a circumferential ring belt 23 for accommodating piston rings (not shown).

The piston base body 11 and the piston ring element 12 together form a circumferential cooling channel 24 that is formed between an inner mantle surface 25 in the region of the combustion bowl 21 and an outer mantle surface 26 in the region of the ring belt 23. Because the exemplary embodiment shown here involves a piston having a thermally uncoupled piston skirt, the cooling channel 24 is closed off with a closure element 27, in known manner. In the exemplary embodiment, the closure element 27 is held on the piston ring element 12 in the region of the ring belt 15.

Because of the radial offset d of the combustion bowl 21, the cross-section of the cooling channel 24 varies in size in the circumferential direction. The outer mantle surface 26 of the cooling channel 24 preferably runs parallel to the center axis M of the piston 10. However, at least one mantle surface 25, 26 of the cooling channel 24 can also run parallel to the center axis A of the combustion bowl 21.

In the exemplary embodiment shown in FIG. 1, the piston ring element 12 is configured to be completely symmetrical, i.e. with rotation symmetry. The radial width of the outer portion 19b of the piston crown is constant in the circumferential direction. This means that such a piston ring element 12 can be combined with piston base bodies that are configured asymmetrically to varying degrees.

The piston base body 11 and the piston ring element 12 are connected with one another by means of joining, in the exemplary embodiment preferably by means of laser welding. As a result, a joining seam 28 is formed between the inner portion 19a and the outer portion 19b of the piston crown, which seam runs parallel to the center axis M of the piston 10 in this particularly preferred exemplary embodiment.

The configuration of the piston 10 according to the invention makes it possible to vary the interior of the subsequent cooling channel 24 before joining the piston base body 11 and the piston ring element 12, in order to bring about an optimal cooling oil flow and to improve the cooling effect.

In the exemplary embodiment according to FIG. 1, a flow guide element 31 is accommodated in the cooling channel 24, which element brings about a central constriction of the cross-section of the cooling channel 24. The flow guide element 31 is formed, in one piece, for example by means of casting or forging, on the outer mantle surface 26, i.e. on the piston ring element 12 before joining the piston base body 11 and the piston ring element 12. The central constriction of the cross-section of the cooling channel 24 brings about acceleration of the flow of the cooling oil as well as turbulence of the cooling oil in the non-constricted regions of the cooling channel 24, so that improved heat dissipation from the piston head 13 in the direction of the piston skirt 14 takes place.

FIG. 2 shows an enlarged partial representation of a further exemplary embodiment of a piston 110 composed of a piston base body 111 and a piston ring element 112. The piston 110 essentially corresponds to the piston 10 according to FIG. 1, so that structural elements that agree with one another are provided with the same reference symbols, and reference is made, in this regard, to the figure description of FIG. 1.

The significant different as compared with the piston 10 according to Figure consists in that the combustion bowl 121 is not disposed radially offset or tilted relative to the center axis M of the piston 110. Furthermore, a heat conducting element 132 is configured in the cooling channel 124. The heat conducting element 132 is configured to narrow acutely in cross-section, whereby the tip 132a projects into the cooling channel 124 at a slant downward. The heat conducting element 132 is formed, in one piece, for example by means of casting or forging and/or mechanical working, in the inner mantle surface 125, i.e. in the basic piston body 111, before the piston base body 111 and the piston ring element 112 are joined. The heat conducting element 132 is preferably disposed underneath the bowl edge 121a of the combustion bowl 121 and brings about preferential heat dissipation from the bowl edge 121a in the direction of the coolant accommodated in the cooling channel 124, and thereby in the direction of the piston skirt. In this exemplary embodiment, the outer mantle surface 126 runs parallel to the center axis M of the piston 110.

FIG. 3 shows an enlarged partial representation of a further exemplary embodiment of a piston 210 composed of a piston base body 211 and a piston ring element 212. The piston 210 essentially corresponds to the piston 10 according to FIG. 1, so that structural elements that agree with one another are provided with the same reference symbols, and reference is made, in this regard, to the figure description of FIG. 1.

A significant difference from the piston 10 according to Figure consists in that the cooling channel 224 is configured to be closed. The piston base body 211 and the piston ring element 212 are connected with one another, for example welded to one another, by way of joining seams 28, 233. The joining seam 28 is formed between the inner portion 19a and the outer portion 19b of the piston crown and runs parallel to the center axis M of the piston 210 in this preferred exemplary embodiment. The joining seam 233 is formed between the pin boss connection 234 of the piston base body 211 and the ring belt 23 of the piston 210, and also runs parallel to the center axis M of the piston 210.

A further difference from the piston 10 according to FIG. 1 consists in that the combustion bowl 221 is not disposed radially offset or tilted relative to the center axis M of the piston 210. Furthermore, a heat conducting element 232 is configured in the cooling channel 224. The heat conducting element 232 is configured to narrow acutely in cross-section, whereby the tip 232a projects into the cooling channel 224 at a downward slant. The heat conducting element 232 is formed, in one piece, for example by means of casting or forging and/or mechanical working, in the inner mantle surface 225, i.e. in the piston base body 211, before the piston base body 211 and the piston ring element 212 are joined. The heat conducting element 232 is preferably disposed underneath the bowl edge 221a of the combustion bowl 221 and brings about preferential heat dissipation from the bowl edge 221a in the direction of the coolant accommodated in the cooling channel 224, and thereby in the direction of the piston skirt. In this exemplary embodiment, the outer mantle surface 226 runs parallel to the center axis M of the piston 210.

FIG. 4 shows a further exemplary embodiment of a piston 310 according to the invention. The piston 310 essentially corresponds to the piston 210 according to FIG. 3, so that reference is made to the figure description of FIG. 3.

The single difference from the piston 210 according to FIG. 3 consists in that in the piston 310 according to Figure, a flow guide element 331 is accommodated in the cooling channel 324, which element brings about a central constriction of the cross-section of the cooling channel 324. The flow guide element 331 is formed, in one piece, for example by means of casting or forging and/or mechanical working, on the outer mantle surface 326, i.e. on the piston ring element 312 before joining the piston base body 311 and the piston ring element 312. The central constriction of the cross-section of the cooling channel 324 brings about acceleration of the flow of the cooling oil as well as turbulence of the cooling oil in the non-constricted regions of the cooling channel 324, so that improved heat dissipation from the piston head in the direction of the piston skirt takes place.

1. Piston (10, 110, 210, 310) for an internal combustion engine, having a piston head (13) and a piston skirt (14), wherein the piston (10, 110, 210, 310) has a piston base body (11, 111, 211, 311) and a piston ring element (12, 112, 212, 312), and wherein the piston head (13) has a combustion bowl (21, 121, 221, 311),
wherein
the piston ring element (12, 112, 212, 312) has a portion (19b) of a piston crown, a circumferential top land (22), and a circumferential ring belt (23) provided with ring grooves,
the piston base body (11, 111, 211, 311) and the piston ring element (12, 112, 212, 312) form a circumferential cooling channel (24, 124, 224, 324) that is formed between an inner mantle surface (25, 125, 225) in the region of the combustion bowl (21, 121, 221) and an outer mantle surface (26, 126, 226, 326) in the region of the ring belt (23),
in the cooling channel (24, 124, 224, 324), at least one flow guide element (31, 331) is provided on the outer mantle surface (26, 226) and/or at least one heat conducting element (132, 232) is provided on the inner mantle surface (125, 225);
the piston base body (11, 111, 211, 311) and the piston ring element (12, 112, 212, 312) have a circumferential joining seam (28) in the region of the piston crown (19a, 19b), by way of which seam they are non-releasably connected with one another.

2. Piston according to claim 1, wherein the joining seam (28) runs parallel to the center axis (M) of the piston (10, 110, 210, 310).

3. Piston according to claim 1, wherein the cooling channel (224, 324) is configured as a closed cooling channel and wherein the piston base body (211, 311) and the piston ring element (212, 312) are non-releasably connected with one another in the region of a pin boss connection (234) of the piston (210, 310), by way of a second circumferential joining seam (233).

4. Piston according to claim 3, wherein the second circumferential joining seam (233) runs parallel to the center axis (M) of the piston (210, 310).

5. Piston according to claim 1, wherein the cooling channel (24, 124) is configured to be open in the direction of the piston skirt (14) and is closed off with a closure element (27).

6. Piston according to claim 5, wherein the closure element (27) is held on the piston ring element (12, 112) in the region of the ring belt (23).

7. Piston according to claim 1, wherein a circumferential recess (15) is formed between the piston head (13) and the piston skirt (14).

8. Piston according to claim 1, wherein the piston base body (11) has a combustion bowl (21) that is radially offset and/or tilted relative to the center axis (M) of the piston (10), a portion (19a) of a piston crown, as well as the piston skirt (14).

9. Piston according to claim 8, wherein the radial offset (d) of the combustion bowl (21) relative to the center axis (M) of the piston (10) amounts to as much as 3 mm.

10. Piston according to claim 8, wherein the center axis (A) of the combustion bowl (21) encloses an acute angle (a) of up to 10° with the center axis (M) of the piston (10, 110).

11. Piston according to claim 10, wherein the inner mantle surface (25) and/or the outer mantle surface (26) of the cooling channel (24) runs parallel to the center axis (A) of the combustion bowl (21).

12. Piston according to claim 1, wherein the outer mantle surface (26, 126, 226, 326) of the cooling channel (24, 124, 224, 324) runs parallel to the center axis (M) of the piston (10, 110, 210, 310).
